(19) United States
(12) Patent Application Publication
(10) Pub. No.: US 2013/0143140 A1
(43) Pub. Date: Jun. 6, 2013

(54) SOLID OXIDE FUEL CELL AND METHOD OF MANUFACTURING THE SAME

(71) Applicants: Jong Sik Yoon, Seoul (KR); Jong Ho Chung, Gyunggi-do (KR); Eon Soo Lee, Gyeongsangbuk-do (KR); Jai Hyoung Gil, Seoul (KR); Sung Han Kim, Seoul (KR)

(72) Inventors: Jong Sik Yoon, Seoul (KR); Jong Ho Chung, Gyunggi-do (KR); Eon Soo Lee, Gyeongsangbuk-do (KR); Jai Hyoung Gil, Seoul (KR); Sung Han Kim, Seoul (KR)

(73) Assignee: SAMSUNG ELECTRO-MECHANICS CO., LTD., Gyunggi-do (KR)

(21) Appl. No.: 13/432,050

(22) Filed: Mar. 28, 2012

(30) Foreign Application Priority Data
Dec. 1, 2011 (KR) 1020110127566

(51) Int. Cl. H01M 8/24; H01M 8/00

(52) U.S. Cl. 429/466; 429/535

(57) ABSTRACT

Disclosed herein is a solid oxide fuel cell. The solid oxide fuel cell includes cylindrical fuel cells and a current collector. The fuel cells are inserted into the current collector so that the fuel cells are connected in parallel to each other. The current collector includes an upper plate and a lower plate. The upper plate includes protruding parts each having a slot. An upper connection part connects the protruding parts in parallel to each other. The lower plate has a mesh structure and has semicircular support parts corresponding to the respective protruding parts. A lower connection part connects the semicircular support parts in parallel to each other. The solid oxide fuel cell unitizes connection between the fuel cells and current collection, thus simplifying a current collecting process, and minimizing a connection loss that may be induced in connection between the fuel cells.

### CROSS REFERENCE TO RELATED APPLICATION

This application claims the benefit of Korean Patent Application No. 2011-0127566, filed Dec. 1, 2011, entitled “SOLID OXIDE FUEL CELL STACK AND PRODUCING METHOD THEREOF”, which is hereby incorporated by reference in its entirety into this application.

### BACKGROUND OF THE INVENTION

1. Technical Field

The present invention relates to a solid oxide fuel cell and a method of manufacturing the solid oxide fuel cell.

2. Description of the Related Art

Generally, solid oxide fuel cells (SOFCs) use an oxygen or hydrogen ion-conducting solid oxide as an electrolyte and operate at the highest temperature range (from 700° C. to 1000° C.) among fuel cells. The solid fuel cell is advantageous in that the structure thereof is simple compared to other fuel cells because all the elements thereof are solid, there is no problem with the loss, replenishment or corrosion of an electrolyte, a precious metal catalyst is not required, and fuel can be easily supplied through direct internal reforming.

Further, there is an advantage in that heat and power generation using waste heat can be performed in combination because of the discharge of high-temperature gas. Thanks to these advantages, advanced countries, such as the U.S.A., Japan and the like, are actively researching SOFCs with a goal for commercialization them in the early 21st century.

Typical SOFCs include a fine oxygen ion-conducting electrolyte layer and a porous cathode and anode disposed on opposite sides of the oxygen ion-conducting electrolyte layer. The operating principle of such a solid oxide fuel cell is as follows. Oxygen reaches the surface of an electrolyte through the porous cathode and is converted into oxygen ions by reduction of the oxygen. The oxygen ions move to the porous anode through the fine electrolyte and react with hydrogen supplied to the porous anode, thus producing water. In this case, electrons are generated at the anode and are consumed at the cathode, so that an electrical current flows between the cathode and anode when the two electrodes are connected to each other. To practically use electricity generated by the above-mentioned principle, predetermined levels of voltage and current are required. Therefore, a fuel cell stack is used as the entire fuel cell system, in which several unit cells are connected in series and in parallel to each other by interconnects and current collectors.

A wire winding method and an interconnect method are representative examples of conventional methods for connection between cells or current collection. In the wire winding method, highly conductive wires are wound around electrodes to collect the current, and these current collection wires extend and connect cells to each other. In the interconnect method, an interconnect is made of a LaCrO₃-based ceramic and is formed outside each fuel cell so that cells are connected to each other by the interconnects and the current is collected.

An example of the wire winding method was proposed in Korean Patent Laid-open Publication No. 2011-0085848, in which wires are wound around electrodes to collect the current. However, the larger the size of a cell, the longer the wires for current collection. The increase in the length of the wires results in an increase in resistance. Eventually, the increase in current collection resistance reduces the performance of the cell, thus deteriorating the performance of the entire system.

An example of the interconnect current collection method was proposed in Japanese Patent Laid-open Publication No. 2010-0007862. However, in this method, an excessively large number of connection points are required to connect cells to each other. Thus, when manufacturing a fuel cell stack, the efficiency of converting fuel cells into a fuel cell stack is higher than that of the wire winding method, but a defect of only one portion may make the entire fuel cell stack useless, thus reducing the production yield.

### SUMMARY OF THE INVENTION

The present invention has been made in an effort to provide a solid oxide fuel cell that unitizes connection between fuel cells and current collection, thus simplifying a current collecting process and minimizing a connection loss that may be induced in connection between the fuel cells.

The present invention also provides a method of manufacturing a solid oxide fuel cell that can minimize the number of parts required to manufacture a fuel cell stack, thus reducing the cost of producing the fuel cell stack.

In a solid oxide fuel cell according to an embodiment of the present invention, cylindrical fuel cells are provided. Each cylindrical fuel cell includes a cylindrical anode. An electrolyte membrane is provided around a circumferential outer surface of the cylindrical anode. A cathode is provided around a circumferential outer surface of the electrolyte membrane. An interconnect is provided at a predetermined position on the circumferential outer surface of the cylindrical anode in a shape of a longitudinal band. The interconnect protrudes outwards from a circumferential outer surface of the cathode and being spaced apart from the cathode. Each cylindrical fuel cell further includes a current collector into which the cylindrical fuel cells are inserted so that the cylindrical fuel cells are connected in parallel to each other. The current collector includes an upper plate having protruding parts with a slot formed in each of the protruding parts. An upper connection part connects the protruding parts in parallel to each other. The current collector further includes a lower plate which has a mesh structure and includes semicircular support parts corresponding to the respective protruding parts. A lower connection part connects the semicircular support parts in parallel to each other.

The current collector may comprise a plurality of current collectors. The current collectors may be stacked one on top of another so that the interconnects and the corresponding lower plates are electrically connected in series to each other.

Each of the interconnects may protrude through the corresponding slot.

The lower plate may be in close contact with the cylindrical fuel cells.

The lower plate may comprise a conductive mesh structure or a metal body having pores.

The conductive mesh structure may have a mesh size of 10 to 80.

The conductive mesh structure or the metal body may be made of iron, copper, aluminum, nickel, chrome or one selected from among groups consisting of different kinds of alloys of iron, copper, aluminum, nickel and chrome.

The conductive mesh structure or the metal body may be coated for anti-oxidization.

A method of manufacturing a solid oxide fuel cell according to an embodiment of the present invention includes providing cylindrical fuel cells. Each cylindrical fuel cell includes a cylindrical anode. An electrolyte membrane is provided around a circumferential outer surface of the cylindrical anode. A cathode is provided around a circumferential outer surface of the electrolyte membrane. An interconnect is provided at a predetermined position on the circumferential outer surface of the cylindrical anode in a shape of a longitudinal band. The interconnect protrudes outwards from a circumferential outer surface of the cathode and being spaced apart from the cathode. The method further includes providing a current collector. The current collector includes an upper plate having protruding parts with a slot formed in each of the protruding parts. An upper connection part connects the protruding parts in parallel to each other. The current collector further includes a lower plate which has a mesh structure and includes semicircular support parts corresponding to the respective protruding parts. A lower connection part connects the semicircular support parts in parallel to each other. The method further includes inserting the cylindrical fuel cells into the lower plate, and coupling the upper plate to the lower plate such that the interconnects protrude through the corresponding slots of the upper plate, thus connecting the fuel cells in parallel to each other.

The current collector may comprise a plurality of current collectors. The method may further include stacking the current collectors one on top of another so that the interconnects and the corresponding lower plates are electrically connected in series to each other.

The upper plate may be coupled to the lower plate by a bolt or rivet.

The lower plate may come into close contact with the cylindrical fuel cells.

The lower plate may comprise a conductive mesh structure or a metal body having pores.

The conductive mesh structure may have a mesh size of 10 to 80.

The conductive mesh structure or the metal body may be made of iron, copper, aluminum, nickel, chrome or one selected from among the groups consisting of different kinds of alloys of iron, copper, aluminum, nickel and chrome.

The conductive mesh structure or the metal body may be coated for anti-oxidization.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a cylindrical fuel cell, according to an embodiment of the present invention;

FIG. 2 is a sectional view of the cylindrical fuel cell according to the embodiment of the present invention;

FIG. 3 is a schematic exploded perspective view showing the assembly of a current collector, according to an embodiment of the present invention; and

FIG. 4 is a sectional view of a fuel cell stack according to an embodiment of the present invention.

### DESCRIPTION OF THE PREFERRED EMBODIMENTS

Reference should now be made to the drawings, in which the same reference numerals are used throughout the different drawings to designate the same or similar components. If, in the specification, detailed descriptions of well-known functions or configurations may unnecessarily make the gist of the present invention obscure, the detailed descriptions will be omitted. The terms and words used in the present specification and the accompanying claims should not be limitedly interpreted as having their common meanings or those found in dictionaries, but should be interpreted as having meanings adapted to the technical spirit of the present invention on the basis of the principle that an inventor can appropriately define the concepts of terms in order to best describe his or her invention. Furthermore, it will be understood that, although the terms “upper”, “lower” etc. may be used herein to describe different elements, components, regions, layers and/or sections, these elements, components, regions, layers and/or sections should not be limited by these terms. These terms are only used to distinguish one element, component, region, layer or section from another element, component, region, layer or section.

Hereinafter, the present invention will be described in detail with reference to the attached drawings.

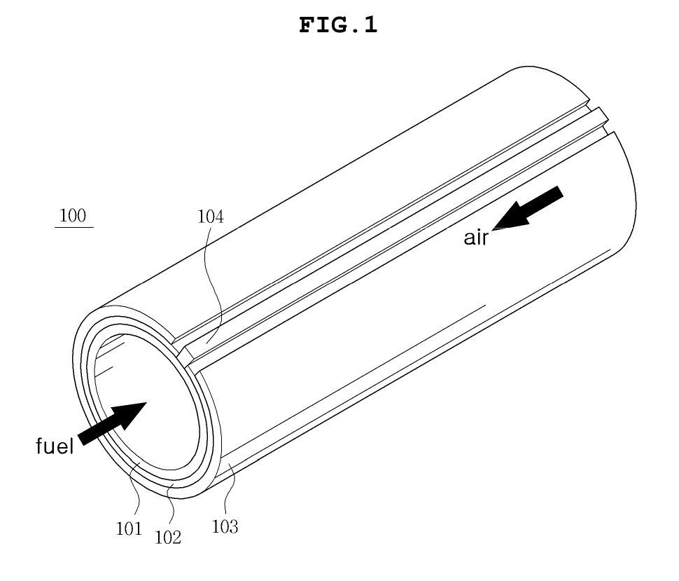

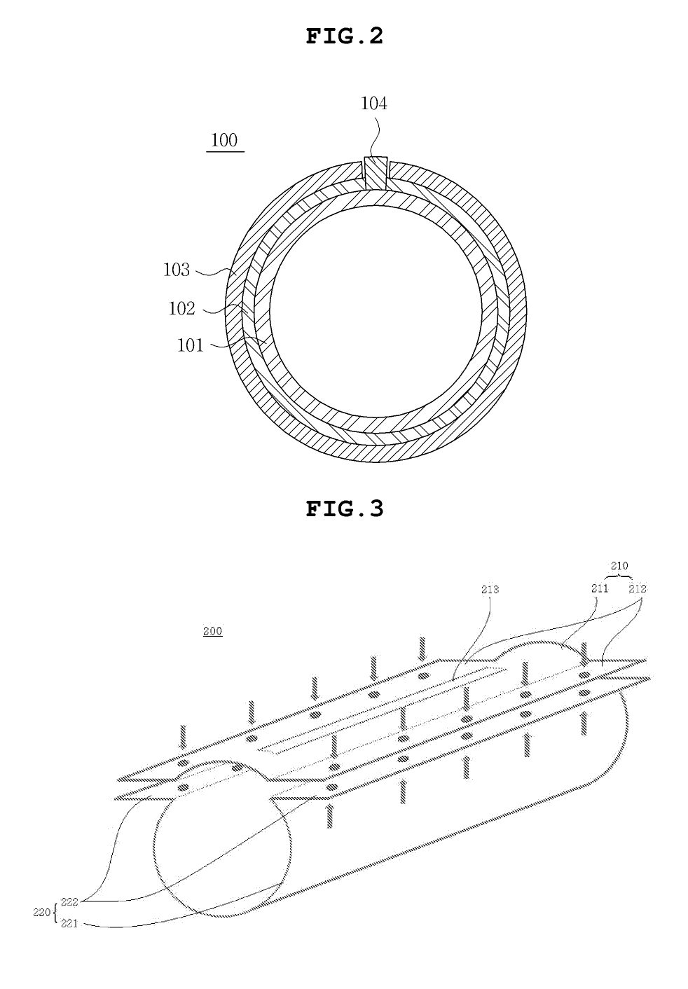

FIGS. 1 and 2 are, respectively, a perspective view and a sectional view showing a cylindrical fuel cell 100, according to an embodiment of the present invention. As shown in FIGS. 1 and 2, the cylindrical fuel cell 100 according to the embodiment of the present invention includes a cylindrical anode 101, an electrolyte membrane 102, a cathode 103 and a interconnect 104. In detail, the electrolyte membrane 102 is provided around a circumferential outer surface of the cylindrical anode 101. The cathode 103 is provided around a circumferential outer surface of the electrolyte membrane 103. The interconnect 104 is provided at a predetermined position on the circumferential outer surface of the cylindrical anode 101 and has the shape of a band that extends a predetermined length in a longitudinal direction of the cylindrical anode 101. The interconnect 104 protrudes outwards from a circumferential outer surface of the cathode 103 and is spaced apart from the cathode 103.

The cylindrical anode 101 functions to support the entirety of the fuel cell 100, and can be formed by heating NiO—YSZ (nickel oxide-yttria-stabilized zirconia) at a temperature of 1200° C. to 1300° C. Forming the electrolyte membrane 102 includes coating the circumferential outer surface of the anode 101 with YSZ (yttria-stabilized zirconia) or ScSZ (scandium-stabilized zirconia), GDC, LDC or the like using a slip coating or plasma spray coating method, and sintering the coated anode 101 at a temperature of 1300° C. to 1500° C. The cathode 103 can be formed by coating the circumferential outer surface of the electrolyte membrane 102 with LSM (strontium doped lanthanum manganite), LSCF ((La,Sr)(Co,Fe)O₃) or the like using a slip coating or plasma spray coating method and then sintering the coated electrolyte membrane 102 at a temperature of 1200° C. to 1300° C.

The interconnect 104 is provided after the anode 101, the electrolyte membrane 102 and the cathode 103 have been stacked in sequence. The interconnect 104 comes into contact with a lower plate 220 of a current collector 200, which will be explained later herein, and functions to transmit the current generated in the cathode 103 to the current collector 200. In detail, the interconnect 104 protrudes outwards from a predetermined portion of the circumferential outer surface of the anode 101 and comes into contact with the lower plate 220 of the current collector 200. In an embodiment, the interconnect 104 is made of a conductive material so that it functions as an element for current collection of the anode 101. Further, to prevent a short between the interconnect 104 and the cathode 103, the interconnect 104 is spaced apart from the cathode 103 by a predetermined distance, or an insulation layer (not shown) is provided between the cathode 103 and the interconnect 104. In addition, the interconnect 104 protrudes upwards in consideration of reliability of contact with a lower plate 220 of the current collector 200, which will be explained in detail later herein.

Hereinafter, the current collector 200, into which the fuel cell 100 is inserted, and which forms a fuel cell stack, will be described.

FIG. 3 is a schematic exploded perspective view showing the assembly of a current collector 200 according to an embodiment of the present invention. As shown in FIG. 3, the current collector 200 includes an upper plate 210 and a lower plate 220. The upper plate 210 includes protruding parts 211 each of which has a slot 213 therein, and upper connection parts 212 that connect the protruding parts 211 in parallel to each other. The lower plate 220 has a mesh structure and includes semicircular support parts 221 that correspond to the respective protruding parts 211, and lower connection parts 222 that connect the semicircular support part [symbol] 221 in parallel to each other.

The present invention uses the integrated current collector for current collection and connection between cells that is manufactured using a conductive mesh structure or a metal body having pores, thus substituting for the conventional method in which the silver wire is wound around the electrodes or a nickel (Ni) felt/mesh or the like is added to the outer surface of the fuel cell, whereby current of the cathode or anode is collected, and fuel cells are connected to each other to form a fuel cell stack. Therefore, the present invention can modularize the structure for current collection and connection between cells, thus facilitating not only manufacture of a fuel cell stack but also current collection. Here, it is preferable for the conductive mesh structure to have a mesh size of 10 to 80, taking into account the supply of air and the efficiency of current collection. The conductive mesh structure supplies air to the surface of the fuel cell 100 through pores that are formed in the mesh itself. The conductive mesh structure or the porous metal body is rolled in a shape corresponding to that of the fuel cell 100 and is formed in a semicircular shape such that the interconnect 104 is exposed to the outside therefrom, thus forming the lower plate 220 of the current collector 200. The fuel cells 100 are inserted into the lower plate 220 which has been formed by the above-mentioned process. Subsequently, the upper plate 210 that has the slots 213, the shape of which corresponds to that of the interconnect 104, is coupled to the lower plate 220 (on portions designated by the arrows of FIG. 3), so that the current can be collected outside the fuel cell.

In an embodiment, the lower plate 220 may comprise an integrated structure including a plurality of semicircular support parts 221 and lower connection parts 222 that connect the semicircular support parts 221 in parallel to each other. In this case, the lower plate 220 comprises a conductive mesh structure or a porous metal body that has gas permeability and facilitates connection to the fuel cells 100. Also, it is preferable for the conductive mesh structure to have a mesh size of 10 to 80, taking into account the supply of air and the efficiency of current collection. The integrated lower plate 220 may be manufactured by an extruding process or the like such that the semicircular support parts 221 and the lower connection parts 222 are formed at the same time. Alternatively, the integrated lower plate 220 may be manufactured in such a way that the semicircular support parts 221 and the lower connection parts 222 are formed by separate processes and then integrally connected to each other. The above-mentioned manufacturing methods are only illustrative examples, and other methods may be used and must be regarded as falling within the bounds of the present invention so long as they can make the same product as the integrated lower plate 220.

The shape of each slot 213 is that of a longitudinal band so that the corresponding interconnect 104 can protrude outwards through the slot 213 and come into contact with the corresponding lower plate 220. The semicircular support part 221 of the lower plate 220 has a semicircular shape such that it can come into close contact with the surface of the corresponding cylindrical fuel cell 100 so that current generated in the cathode 103 can be collected.

Furthermore, air must be supplied to the cathode 103 to generate current. For this, the current collector 200 of the present invention is configured such that air is supplied to the cathode 103 through the lower plate 220 that comprises the conductive mesh structure or the porous metal body. Therefore, it is preferable for the lower plate 220 of the current collector 200 to be the conductive mesh structure or the porous metal body that has gas permeability and facilitates connection between the fuel cells 100. Here, it is preferable for the conductive mesh structure to have a mesh size of 10 to 80, taking into account the supply of air and the efficiency of current collection. The porous metal body may comprise a metal foam, a metal plate or a metal fiber. In consideration of the efficiency of the solid oxide fuel cell, the strength required, etc., the conductive mesh structure or the porous metal body is made of iron, copper, aluminum, nickel, chrome or one selected from among groups consisting of different kinds of alloys thereof. To ensure durability at a high temperature, the conductive mesh structure or the porous metal body may be coated for anti-oxidization with silver (Ag) or conductive ceramics (MnCo, NiCl, LSC, LSCF etc.).

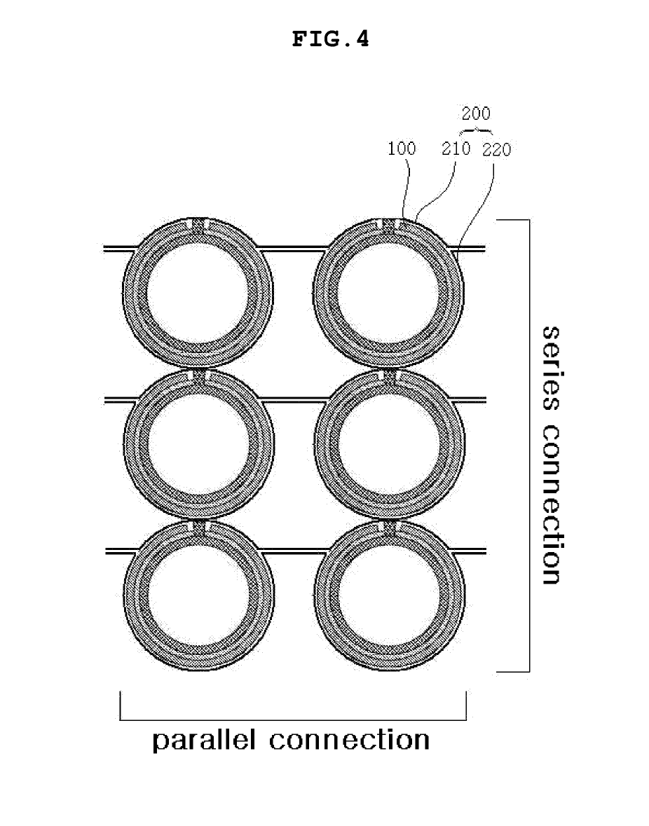

Referring to FIG. 4, the current collector 200 may comprise an extended structure such that a plurality of fuel cells are connected in parallel to each other. The fuel cells that are connected in parallel to each other by a single sheet of mesh form a single unit module. A plurality of unit modules, each of which has the fuel cells connected in parallel to each other, are stacked one on top of another such that the interconnect 104 of each fuel cell 100 comes into contact with the lower plate 220 of a corresponding adjacent current collector 200, thus forming a fuel cell stack in which the fuel cells 100 are connected in series and in parallel to each other. Thereby, the present invention can substitute for the complex conventional method of internal stack connection in which an expensive precious metal is wound around each of the unit fuel cells for current collection and the unit fuel cells are separately connected in series and in parallel to each other.

A method of manufacturing the solid oxide fuel cell stack according to the present invention includes inserting the cylindrical fuel cells 100 into the lower plate 220 of the current collector 200, coupling the upper plate 210 to the lower plate 220 so that a plurality of unit modules are formed, and stacking the unit modules one on top of another.

In detail, an embodiment of the method includes providing a plurality of cylindrical fuel cells 100, each of which includes a cylindrical anode 101, a electrolyte membrane 102 that is provided around a circumferential outer surface of the cylindrical anode 101, a cathode 103 that is provided around a circumferential outer surface of the electrolyte membrane 103, and a interconnect 104 that is provided at a predetermined position on the circumferential outer surface of the cylindrical anode 101 and has the shape of a band that extends a predetermined length in a longitudinal direction of the cylindrical anode 101 and is spaced apart from the cathode 103. The method further includes inserting the fuel cells 100 into a current collector 200 such that the fuel cells 100 come into close contact with the current collector 200, thus forming a unit module in which the fuel cells 100 are connected in parallel to each other. The current collector 200 includes an upper plate 210 and a lower plate 220. The upper plate 210 includes protruding parts 211 each of which has a slot 213 therein, and upper connection parts 212 that connect the protruding parts 211 in parallel to each other. The lower plate 220 has a mesh structure and includes semicircular support parts 221 that correspond to the respective protruding parts 211, and lower connection parts 222 that connect the semicircular support part 221 in parallel to each other. Here, the fuel cells 100 are inserted into the lower plate 220 of the current collector 200. The upper plate 210 is coupled to the lower plate 220 such that the interconnects 104 of the fuel cells 100 protrude outwards through the corresponding slots 213 formed in the protruding parts 211 of the upper plate 210. The coupling of the upper plate 210 to the lower plate 220 can be realized by typical bolts, rivets etc., by a method of applying pressure thereto, or the like.

Furthermore, a plurality of current collectors 200 into which the fuel cells 100 are inserted are stacked one on top of another so that the interconnect 104 of each fuel cell 100 comes into contact with the lower plate 220 of the corresponding adjacent current collector 200, thus forming a solid oxide fuel cell stack in which the fuel cells 100 are connected in series and in parallel to each other.

As described above, in the present invention, a current collector is a base unit. Fuel cells can be easily connected in series to each other merely by stacking several current collectors one on top of another, thus forming a fuel cell stack. Further, the present invention can minimize the number of parts required to manufacture the fuel cell stack, thus simplifying the structure of the fuel cell stack. In addition, a conductive mesh structure or a porous metal body is used so that unitization of connection between the fuel cells and current collection can be realized, thus simplifying the current collection process, thereby minimizing a connection loss that may be induced in connection between the fuel cells.

Although the embodiments of the present invention have been disclosed for illustrative purposes, it will be appreciated that the solid oxide fuel cell and the method of manufacturing according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell, comprising:
cylindrical fuel cells each comprising: a cylindrical anode; an electrolyte membrane provided around a circumferential outer surface of the cylindrical anode; a cathode provided around a circumferential outer surface of the electrolyte membrane; and an interconnect provided at a predetermined position on the circumferential outer surface of the cylindrical anode in a shape of a longitudinal band, the interconnect protruding outwards from a circumferential outer surface of the cathode and being spaced apart from the cathode; and
a current collector into which the cylindrical fuel cells are inserted so that the cylindrical fuel cells are connected in parallel to each other, the current collector comprising: an upper plate having protruding parts with a slot formed in each of the protruding parts, and an upper connection part connecting the protruding parts in parallel to each other; and a lower plate having a mesh structure and having semicircular support parts corresponding to the respective protruding parts, and a lower connection part connecting the semicircular support parts in parallel to each other.

2. The solid oxide fuel cell as set forth in claim 1, wherein the current collector comprises a plurality of current collectors stacked one on top of another so that the interconnects and the corresponding lower plates are electrically connected in series to each other.

3. The solid oxide fuel cell as set forth in claim 1, wherein each of the interconnects protrudes through the corresponding slot.

4. The solid oxide fuel cell as set forth in claim 1, wherein the lower plate is in close contact with the cylindrical fuel cells.

5. The solid oxide fuel cell as set forth in claim 1, wherein the lower plate comprises a conductive mesh structure or a metal body having pores.

6. The solid oxide fuel cell as set forth in claim 5, wherein the conductive mesh structure has a mesh size of 10 to 80.

7. The solid oxide fuel cell as set forth in claim 5, wherein the conductive mesh structure or the metal body is made of iron, copper, aluminum, nickel, chrome or one selected from among groups consisting of different kinds of alloys of iron, copper, aluminum, nickel and chrome.

8. The solid oxide fuel cell as set forth in claim 5, wherein the conductive mesh structure or the metal body is coated for anti-oxidization.

9. A method of manufacturing a solid oxide fuel cell, comprising:
providing cylindrical fuel cells each comprising: a cylindrical anode; an electrolyte membrane provided around a circumferential outer surface of the cylindrical anode; a cathode provided around a circumferential outer surface of the electrolyte membrane; and an interconnect provided at a predetermined position on the circumferential outer surface of the cylindrical anode in a shape of a longitudinal band, the interconnect protruding outwards from a circumferential outer surface of the cathode and being spaced apart from the cathode;
providing a current collector comprising: an upper plate having protruding parts with a slot formed in each of the protruding parts, and an upper connection part connecting the protruding parts in parallel to each other; and a lower plate having a mesh structure and having semicircular support parts corresponding to the respective protruding parts, and a lower connection part connecting the semicircular support parts in parallel to each other; and
inserting the cylindrical fuel cells into the lower plate, and coupling the upper plate to the lower plate such that the interconnects protrude through the corresponding slots of the upper plate, thus connecting the fuel cells in parallel to each other.

10. The method as set forth in claim 9, wherein the current collector comprises a plurality of current collectors, the method further comprising:
stacking the current collectors one on top of another so that the interconnects and the corresponding lower plates are electrically connected in series to each other.

11. The method as set forth in claim 9, wherein the upper plate is coupled to the lower plate by a bolt or rivet

12. The method as set forth in claim 9, wherein the lower plate comes into close contact with the cylindrical fuel cells.

13. The method as set forth in claim 9, wherein the lower plate comprises a conductive mesh structure or a metal body having pores.

14. The method as set forth in claim 13, wherein the conductive mesh structure has a mesh size of 10 to 80.

15. The method as set forth in claim 13, wherein the conductive mesh structure or the metal body is made of iron, copper, aluminum, nickel, chrome or one selected from among the groups consisting of different kinds of alloys of iron, copper, aluminum, nickel and chrome.

16. The method as set forth in claim 13, wherein the conductive mesh structure or the metal body is coated for anti-oxidization.
